(19) United States
(12) Patent Application Publication
(10) Pub. No.: US 2014/0157940 A1
(43) Pub. Date: Jun. 12, 2014

(54) CABLE AND OPERATING FORCE TRANSMISSION APPARATUS

(71) Applicants: Masashi Taura, Nagoya (JP); Kazuki Tsuchiya, Nagoya (JP); Yoshikatsu Tsuge, Nagoya (JP)

(72) Inventors: Masashi Taura, Nagoya (JP); Kazuki Tsuchiya, Nagoya (JP); Yoshikatsu Tsuge, Nagoya (JP)

(73) Assignee: CHUO HATSUJO KABUSHIKI KAISHA, Nagoya (JP)

(21) Appl. No.: 14/236,062

(22) PCT Filed: Jul. 31, 2012
(86) PCT No.: PCT/JP2012/069448

§ 371 Date: Jan. 29, 2014

(30) Foreign Application Priority Data
Aug. 10, 2011 (JP) 2011-174789

(51) Int. Cl. F16C 1/14

(52) U.S. Cl. CPC F16C 1/14
USPC 74/502.6; 74/500.5

(57) ABSTRACT

A cable 20 is provided with a cable body 24a, a metal fitting 22a fixed to at least one end of the cable body, and a covering coat 32a covering at least a portion not covered by a metal fitting on a surface of the cable body. The cable body 24a includes a swelling part 30a on an end at a side on which the metal fitting is fixed, and the swelling part 30a swells in a direction orthogonal to an axis of the cable. The metal fitting 22a surrounds a periphery of the swelling part of the cable body. A tip of the covering coat at the side on which the metal fitting is fixed is located in the metal fitting. The space “a” is formed between the swelling part of the cable body and the tip of the covering coat.

### TECHNICAL FIELD

The technique disclosed in the present specification relates to a cable.

### BACKGROUND ART

Japanese Examined Patent Application Publication No. S51-8819 discloses a cable of the prior art. This cable includes a cable body, a metal fitting fixed to an end of the cable body, and a covering coat covering a surface of the cable body. At the end of the cable body, a swelling part which swells in a direction orthogonal to a cable axis is formed. The covering coat covers the cable body up to a root of the swelling part. The metal fitting is firmly fixed to the cable body so as to surround a tip of the covering coat and a periphery of the swelling part of the cable body.

### SUMMARY OF INVENTION

### Technical Problem

This type of cable is generally utilized for transmitting the operating force input into an input apparatus (e.g. an operation lever or the like) to an output apparatus (e.g. braking apparatus or the like). Thus, stress is repeatedly generated on the cable in every operation, and a desired durability (i.e., the cable is not damaged even if the cable is operated over a predetermined number of times) is required for the cable. The durability of the cable is generally determined by a diameter of the cable body, a material of the cable body, and the like. Hence, when designing a cable, various factors with respect to the cable are at first tentatively determined on the basis of the durability required for the cable and of the stress generated on the cable. Then, a trial product of the cable is actually produced, and the durability of the trial product for the cable is confirmed by an experiment.

However, when a cable of the conventional structure shown in Japanese Examined Patent Application Publication No. S51-8819 is applied for specific applications (e.g. a parking brake apparatus of a car or the like), it would be damaged by a number of use less than the desired number of use even if the stress exerted on the cable seems small. In such a case, various factors with respect to the cable are reconsidered so as to achieve the desired durability. Consequently, a cable having a relatively large diameter would be utilized. As the diameter becomes larger, the amount of material required for the cable becomes larger. Therefore, it causes problems of increasing the weight and the cost or the like.

The present specification has an object to provide a cable which can enhance the durability without increasing the cable diameter.

### Solution to Problem

The inventors of the present application searched for a cause of the cable damage and found the followings: (1) the cable is damaged at the root of the swelling part of the cable body (i.e. at the tip of the covering coat); and (2) for the specific applications in which the cable has been damaged during an early stage, the axis of the cable body is an inclined or twisted state with respect to the mounting side member (i.e. the metal fitting) during the cable operation. On the basis of these findings, it has been considered that since the operating force is exerted on the cable with the cable body being in the inclined or twisted state with respect to the mounting side member, the prying force is exerted on the cable body and causes the damage on the cable body during an early stage. The cable disclosed in the present specification has been created based on such consideration.

A cable disclosed in the present specification includes a cable body, a metal fitting fixed to at least one end of the cable body, and a covering coat covering at least a portion not covered by the metal fitting on a surface of the cable body. The cable body includes a swelling part on an end at a side on which the metal fitting is fixed, and the swelling part swells in a direction orthogonal to an axis of the cable. The metal fitting surrounds a periphery of the swelling part of the cable body. A tip of the covering coat at a side on which the metal fitting is fixed is located in the metal fitting. Further, a space is formed between the swelling part of the cable body and the tip of the covering coat. It should be noted that any member can be utilized as the above-described covering coat as long as it covers at least the portion not covered by the metal fitting on the surface of the cable body, and that a portion covered by the metal fitting on the surface of the cable body may also be covered by the covering coat.

In this cable, the space is formed between the swelling part of the cable body and the tip of the covering coat. Thus, the tensile force exerted on the cable becomes larger at the root of the swelling part of the cable body, whereas the prying force exerted on the cable body becomes larger not at the root of swelling part but at the tip of the covering coat. As a result, the stress generated at the root of the swelling part of the cable body is inhibited, which makes it possible to enhance the durability of the cable. In addition, since only the formation of the space between the swelling part and the tip of the covering coat is required for this cable, it is possible to inhibit the increase of the cable diameter.

For the above-described cable, the space between the swelling part of the cable body and the tip of the covering coat is not less than 1 mm, preferably. In the experiments performed by the inventors of the present application, the sufficient durability was obtained when the space between the swelling part and the tip of the covering coat was made not to be less than 1 mm.

For example, the above-described cable can be suitably utilized for an operating force transmission apparatus. In short, the operating force transmission apparatus disclosed in the present specification comprises a plate member, a first cable having one end connected to the plate member and having other end connected to an input apparatus, a second cable having one end connected to the plate member and having other end connected to a first output apparatus, and a third cable having one end connected to the plate member and having other end connected to a second output apparatus. The operating force input into the input apparatus is transmitted to the first output apparatus and the second output apparatus via the plate member as well as the first cable, the second cable, and the third cable. The above-described cable is utilized as at least one of the first cable, the second cable, and the third cable.

In this operating force transmission apparatus, the operating force input into the input apparatus is transmitted to the plate member via the first cable. The operating force transmitted to the plate member is transmitted to the first output apparatus via the second cable, and to the second output apparatus via the third cable. Since one input into the input apparatus is distributed to two output apparatuses, axes of the first cable, the second cable, and the third cable may become in an inclined or twisted state with respect to the plate member. Therefore, it is possible to suitably enhance the durability by utilizing the above-described cable as any of the first cable, the second cable, and third cable.

### BRIEF DESCRIPTION OF DRAWINGS

FIG. 1 is a view for illustrating a schematic configuration of an operating force transmission apparatus according to an example.

FIG. 2 is a cross section of a cable end (viewed from a side).

FIG. 3 is a cross section of the cable end (viewed from a top).

FIG. 4 is a graph showing a relationship between a durable number of use and a length (distance between a swelling part. and a tip of a covering coat) of a straight part.

### DESCRIPTION OF EMBODIMENTS

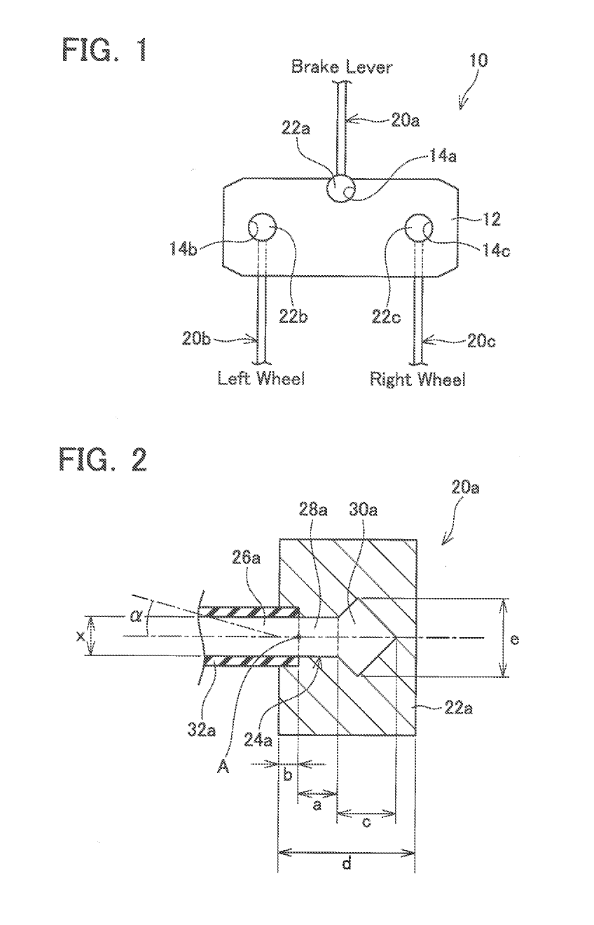

An operating force transmission apparatus 10 according to the present embodiment will be described. The operating force transmission apparatus 10 is utilized for a parking brake apparatus of a vehicle, such as a car. As shown in FIG. 1, the operating force transmission apparatus 10 comprises an equalizer (corresponding to an example of the plate member recited in claims 12, and first to third cables 20a, 20b, 20c having one ends attached to the equalizer 12.

The equalizer 12 is a plate member that has a substantially rectangular shape in plan view, and is disposed to have its own longitudinal direction coinciding with the width direction of the car body. In the equalizer 12, attachment holes 14a to 14c are formed. The attachment hole 14a is disposed at a substantially center position in the longitudinal direction of the equalizer 12 and on a front side of the car body. The attachment holes 14b, 14c are respectively disposed on both ends in the longitudinal direction of the equalizer 12. The attachment holes 14b, 14c arc respectively disposed at symmetrical positions with respect to the axis of the first cable 20a, and closer to the backward side in the car body than the attachment hole 14a.

One end of the first cable 20a is attached to the attachment hole 14a of the equalizer 12, and the other end is connected to a brake lever not shown in figures. One end of the second cable 20b is attached to the attachment hole 14b of the equalizer 12, and the other end is connected to a braking apparatus (i.e. a braking apparatus at the left-rear wheel side) not shown in figures. One end of the third cable 20c is attached to the attachment hole 14c of the equalizer 12, and the other end is connected to another braking apparatus (that is, a braking apparatus at the right-rear wheel side) not shown in figures. By adjusting the tension respectively applied, to the cables 20a, 20b, 20c, the equalizer 12 is held between the brake lever and the right and left braking apparatuses.

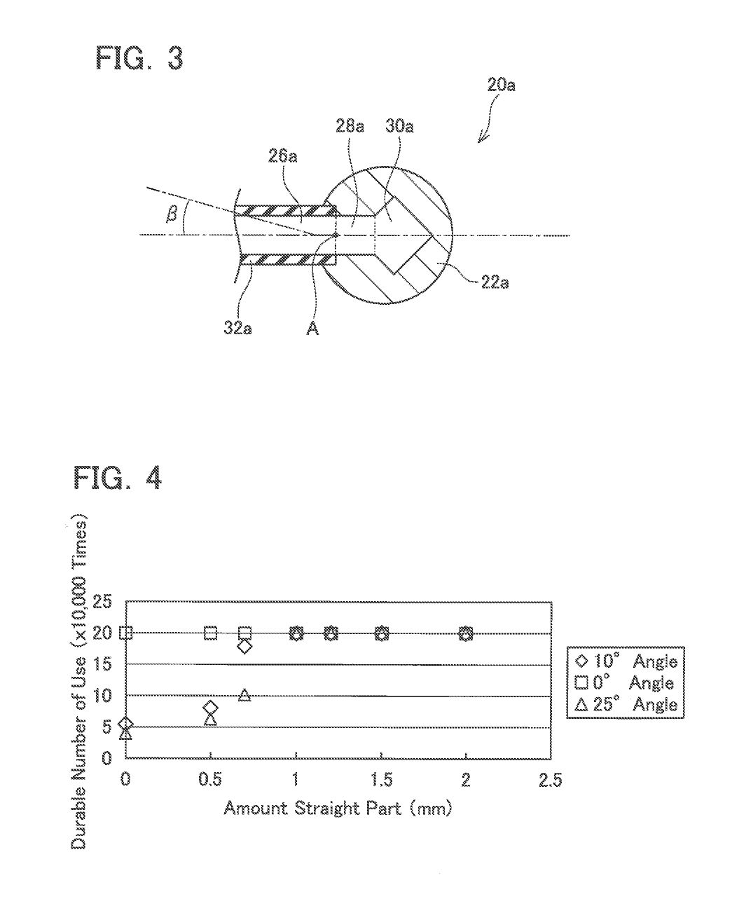

Here, the first cable 20a, the second cable 20b, and the third cable 20c will be described. It should be noted that the first cable 20a, the second cable 20b, and the third cable 20c have the same configuration and thus only the first cable 20a is described below. As shown in FIG. 2 and FIG. 3, the first cable 20a includes a cable body 24a, a covering coat 32a covering a surface of the cable body 24a, and a metal fitting 22a provided at an end of the cable body 24a.

For example, the cable body 24a can be configured with a core wire and a plurality of side wires spirally wound around the core wire. For the core wire and the side wire, it is possible to utilize a stranded wire in which a plurality of steel wires are stranded. As the material of the steel wire, for example, a hard steel wire, a stainless wire, an oil tempered wire (e.g. SWO-A, SWO-B, SWOSC-V, or the like), a bluing wire, or the like can be used. On the surfaces of the core wire and the side wire, it is possible to apply galvanizing for the purpose of rust prevention or the like. It should be noted for the cable body 24a that several known configurations other than the above-described configuration can be adopted. For example, it is possible to adopt a single were structure configured with one steel wire, or a stranded wire structure having no core wire (e.g. a stranded wire in which a plurality of steel wires are stranded). The diameter “x” of the cable body 24a can be determined properly in accordance with the operating force exerted on the cable body 24a. For example, the diameter “x” can be φ 1.0 to 4.0 mm.

At both ends of cable body 24a, a swelling part 30a is formed which swells in a direction orthogonal to the cable axis. It should be noted that although FIG. 2 illustrates only the end of the cable body 24a at the side of the equalizer 12, an end of the cable body 24a at the side of the brake lever is also configured similarly to the end at the side of equalizer 12. The end at the side of equalizer 12 would be described in the following. The swelling part 30a can be formed by compressing a part of the cable body 24a (i.e. a portion having a predetermined length from the end of cable body 24a) in a direction of the cable axis so as to plastically deform the part in a direction orthogonal to the cable axis. Preferably, a dimension (“c” in FIG. 2) of the swelling part 30a in the cable axis direction is 0.5 to 2.0 times larger than the diameter “x” (diameter of a portion other than the swelling part 30a) of the cable body 24a. In addition, it is preferred that a dimension (“e” in FIG. 2) of the swelling part 30a in a direction orthogonal to the cable axis is 1.5 to 3.0 times larger than the diameter “x” (diameter of the portion other than the swelling part 30a) of the cable body 24a. By adopting the above-described dimension for the swelling part 30a, it is possible to firmly join the cable body 24a and the metal fitting 22a. Therefore, it is possible to prevent the separation of the cable body 24a and the metal fitting 22a, even if relatively large tensile force is exerted on the cable body 24a.

The covering coat 32a is formed on a surface of a center part 26a, which is a part of the cable body 24a except for both ends of the cable body 24a. The covering coat 32a is made of resin (e.g., PA66, PA11, PE, or the like) for sealing. The tip of the covering coat 32a is located in the metal fitting 22a. In other words, a gap between the covering coat 32a and the cable body 24a is closed by the metal fitting 22a. Therefore, it is possible to prevent water from entering into the gap between the covering coat 32a and the cable body 24a. Preferably, a dimension “b” (a length in the cable axis direction) of the covering coat 32a located in the metal fitting 22a is not less than 0.5 mm. By adopting the dimension “b” not less than 0.5 mm, it is possible to properly prevent water from entering to the gap between the covering coat 32a and the cable body 24a. On the other hand, it is preferred that the dimension “b” is not more than 2.0 mm in order to prevent the dimension of metal fitting 22a from being increased.

In addition, a space is provided between the tip of the covering coat 32a and the swelling part 30a. By the space, the cable body 24a includes a straight part 28a, which is located in the metal fitting 22a, is not covered by the covering coat 32a, and has a constant diameter. In short, the cable body 24a includes the straight part 28a that is located between the covering coat 32a and the swelling part 30a and is located in the metal fitting 22a. It is preferred that a dimension “a” of the straight part 28a in the cable axis direction is not less than 1.0 mm. As shown by experiments described later, it is possible to dramatically enhance the durability of the first cable 20a by adopting the dimension “a” not less than 1.0 mm for the straight part 28a. In addition, by adopting the dimension “a” not less than 1.0 mm for the straight part 28a, it is possible to firmly join the cable body 24a and the metal fitting 22a. It should be noted that the dimension “a” of the straight part 28a should not be more than 3.0 mm in order to prevent the increase of the dimension of metal fitting 22a.

The metal fitting 22a is formed to have an outer shape similar to that of the first attachment hole 14a of the equalizer 12 (i.e. a cylindrical shape). By fitting the metal fitting 22a into the first attachment hole 14a, the first cable 20a is attached to the equalizer 12. The metal fitting 22a is firmly fixed to the cable body 24a so as to surround the swelling part 30a and the straight part 28a of the cable body 24a as well as the tip of the covering coat 32a. The metal fitting 22a can be formed integrally with the cable body 24a by the insert molding. For example, it is possible for the metal fitting 22a to utilize metal having good adhesiveness to the cable body 24a, such as zinc (die cast). It should be noted that an outer diameter (“d” in FIG. 2) of the metal fitting 22a should be 2.5 to 5.0 times larger than the diameter “x” (diameter of the portion other than the swelling part 30a) of the cable body 24a.

It should be noted that the above-described first cable 20a is guided by an outer casing not shown in figures, and is arranged between the equalizer 12 and the brake lever. However, if the first cable 20a can be arranged without the outer casing, it is not required to provide the outer casing.

When an operator operates the brake lever, the above-described operating force transmission apparatus 10 transmits the operating force to the equalizer 12 via the first cable 20a. The operating force transmitted to the equalizer 12 is transmitted to the braking apparatus (at the left-rear wheel side) via the second cable 20b, and to another braking apparatus (at the right-rear wheel side) via the third cable 20c. Therefore, the braking force is applied to the left-rear wheel and the right-rear wheel.

As described above, the equalizer 12 is hold between the brake lever and the left and right brake apparatuses by the tension exerted on each of the cables 20a, 20b, 20c. Due to the difference in arranging paths of cables 20a, 20b, 20c or the like, for example, the equalizer 12 is changed from the horizontal state to the inclined state (a state in which positions at the right and left sides in the height direction of FIG. 1 are different), or the right and left ends of FIG. 1 are deviated in the front-rear direction of the car body. Thus, in each of cables 20a, 20b, 20c, the axis of the cable body is inclined with respect to the metal fitting (for example, a state in which the inclined angle α of FIG. 2 is not 0°, or a state in which the inclined angle β of FIG. 3 is not) 0°, or twisted. Therefore, the prying force in addition to the tensile force is exerted on each of the cables 20a, 20b, 20c.

Now, for each of the cables 20a, 20b, 20c, the space is formed between the swelling part (30a) of the cable body (24a) and the tip of the covering coat (32a). In other word, the cable body (24a) includes the straight part (28a) between the swelling part (30a) and the covering coat (32a), Thus, the tensile force exerted on each of the cables 20a, 20b, 20c becomes larger at the root of the swelling part (30a) of the cable body (24a), whereas the prying force exerted on the cable body (24a) becomes larger not at the root of the swelling part (30a) but at the tip position the point “A” in FIG. 2 and FIG. 3) of the covering coat (32a). As a result, the stress generated at the root of the swelling part (30a) of the cable body (24a) is inhibited, which makes it possible to enhance the durability of cables 20a, 20b, 20c. In addition, it is possible to avoid increasing the diameter of each of the cables 20a, 20b, 20c, because the only formation of the space between the swelling part (30a) and the tip of the covering coat is required.

FIG. 4 is a graph showing results of the durability test performed with the above-described cables 20a, 20b, 20c manufactured actually. For the cable used for the durability test, the diameter “x” of the cable body was set to be φ 3.0 mm (it should be noted that the diameter was set to be φ 3.6 mm at the portion covered by the covering coat), the dimension (“c” in PIG 2) of the swelling part 30a in the cable axis direction was set to be 4.0 mm, the dimension (“e” in FIG. 2) of the swelling part 30a in a direction orthogonal to the cable axis was set to be 6.0 mm, the length “b” of the covering coat 32a located in the metal fitting 22a was set to be 0.5 mm, and the outer diameter “d” of the metal fitting 22a was set to be 10.0 mm. Then, cables were experimentally produced to respectively have different lengths “a” of the straight part of the cable body, and a plurality of the trial cables were subjected to the experiment with respect to durability. More specifically, the predetermined load (1100N) for the cables was repeatedly exerted on the cables, and the repeating number of the load exertions until the damage of the cable was counted. It should be noted that the maximum repeating number of the load exertions was set to be two hundred thousand. In addition, the inclination angle (α in FIG. 2) of the cable axis was set to be 0°, 10° or 25°.

As shown in FIG. 4, When the inclination angle α of the cable axis was 0°, a durable number of use was two hundred thousand times even with the cable having 0 mm of the straight part. In other word, the cable was not damaged even with the two hundred thousand times of stress exertion. However, the cable having 0 mm of the straight part was damaged with the fifty thousand times of stress exertion or the like, when the inclined angle or of the cable axis was 10 or 25°. On the other hand, even when the inclination angle α was 10° or 25°, the cable having the straight part (a cable of which straight part is not 0 mm) had higher durability than the cable not having the straight part (a cable of which straight part is 0 mm). Especially, the cable having the straight part not less than 1 mm had the two hundred thousand durable times of use, even when the inclination angle α was 10 or 25°. Therefore, it was confirmed that the cable durability could be enhanced dramatically by setting the straight part to be not less than 1.0 mm.

The specific examples of the techniques disclosed in the present specification have been described in detail. However, the examples are illustrative and not restrictive to the claims. The techniques recited in the claims should embrace various modifications of the embodiment illustrated above. For example, although the above-described example relates to a parking apparatus of a car, the cables disclosed in the present specification can be utilized for various other purposes. For example, the cables can be utilized for a power slide door, a seat cable or a door lock cable.

In addition, the technical elements described in the present specification and drawings show the technical advantage independently or with several combinations. Thus, these technical elements are not restricted by the combinations recited in the claims at the filing date. In addition, although the techniques illustrated in the present specification and drawings can reach several goals at the same time, reaching one goal among them is enough to show the technical advantage.

1. A cable, comprising:
a cable body;
a metal fitting fixed to at least one end of the cable body; and
a covering coat covering at least a portion not covered by the metal fitting on a surface of the cable body, wherein
the cable body includes a swelling part on an end at a side on which the metal fitting is fixed, and the swelling part swells in a direction orthogonal to an axis of the cable,
the metal fitting surrounds a periphery of the swelling part of the cable body,
a tip of the covering coat at the side on which the metal fitting is fixed is located in the metal fitting; and
a space is formed between the swelling part of the cable body and the tip of the covering coat.

2. The cable according to claim 1, wherein the space between the swelling part of the cable body and the tip of the covering coat is not less than 1 mm.

3. An operating force transmission apparatus, comprising:
a plate member;
a first cable having one end connected to the plate member and having other end connected to an input apparatus;
a second cable having one end connected to the plate member and having other end connected to a first output apparatus;
and a third cable having one end connected to the plate member and having other end connected to a second output apparatus, wherein
an operating force input into the input apparatus is transmitted to the first output apparatus and the second output apparatus via the plate member as well as the first cable, the second cable, and the third cable, and
at least one of the first cable, the second cable, and the third cable is the cable according to claim 1.
